(19) United States
(12) Patent Application Publication
(10) Pub. No.: US 2026/0332656 A1
(43) Pub. Date: Oct. 22, 2026

(54) INTUITIVE IN-ROOM PARTICIPANT SELECTION FOR ONLINE MEETINGS

(71) Applicant: Cisco Technology, Inc., San Jose, CA (US)

(72) Inventors: Borut Kerzic, Barcelona (ES); Kristian Tangeland, Oslo (NO); Benoit Rouger, Espoo (FI)

(21) Appl. No.: 19/180,712

(22) Filed: Apr. 16, 2025

(51) Int. Cl. H04L 65/4038

(52) U.S. Cl. CPC H04L 65/4038

(57) ABSTRACT

Methods, apparatuses, and systems that generate layouts. A method involves obtaining a first multimedia stream of a collaboration space in which at least two participants are physically present and at least one second multimedia stream of at least one remote participant that is remote from the collaboration space. The at least two participants and the at least one remote participant are collaborating in a collaboration session via user devices. The method involves selecting one or more participants in the collaboration space and generating a layout for displaying the collaboration session. The layout includes an overview panel of the collaboration space and an individual views panel having a plurality of individual frames to display the at least one remote participant and the one or more participants. The method further involves transmitting a multi-stream according to the layout for rendering the collaboration session on a respective user device.

### TECHNICAL FIELD

The present disclosure generally relates to online meeting space environments.

### BACKGROUND

Virtual meeting space environments and video conferencing are popular. Video conferencing typically involves a group of geographically remote participants joining an online meeting via respective user devices for collaboration and content sharing. In recent years, hybrid meetings are becoming popular. In a hybrid meeting, some participants are meeting in person in a meeting room while other participants are remote and join the meeting using a video conferencing service, such as from a home or other remote office. To accommodate these types of meeting environments, video conferencing platforms combine a video stream of a meeting room with video streams of remote participants for an online meeting. However, presenting participants in a meeting room during a video conference can be challenging. When displaying a window in a user interface presented to remote participants, it may be difficult for the remote participants to view individual participants that are physically in the meeting room, and/or their views may be obstructed by other participants or objects in the meeting room. In short, video conferencing in which some participants are in a meeting room while others are remote presents can have challenges.

### BRIEF DESCRIPTION OF THE DRAWINGS

FIG. 1 is a block diagram of an environment in which a layout generator generates a layout for a collaboration session among meeting room participants and remote participants, according to an example embodiment.

FIG. 2 illustrates a layout for displaying a collaboration session in which some participants are physically present in a collaboration space while others are remote from the collaboration space, according to an example embodiment.

FIG. 3 is a diagram depicting a method of generating a multi-stream of a plurality of video streams from a collaboration space, according to an example embodiment.

FIG. 4 is a diagram illustrating rendering of images from a multi-stream associated with a collaboration space, which includes a plurality of video streams generated for video captured from the collaboration space, according to an example embodiment.

FIG. 5 is a diagram depicting a method of providing a multi-stream that includes a plurality of video streams according to a generated layout for rending the collaboration session on a receiving user device, according to an example embodiment.

FIG. 6 illustrates a layout for displaying a collaboration session in which selected participants that are physically present in a collaboration space are displayed in individual frames, according to an example embodiment.

FIG. 7 illustrates rendered and hidden images of video streams in a multi-stream of a collaboration session, according to an example embodiment.

FIG. 8 illustrates an overview panel for enabling a layout generator to generate a custom layout specific to a respective participant, according to an example embodiment.

FIG. 9 is a diagram depicting a method of generating, by a layout generator, an individual frame in a dynamic panel based on a selection of a participant in a collaboration space, according to an example embodiment.

FIG. 10 illustrates an individual frame in a dynamic panel that has features for adjusting the dynamic panel, according to an example embodiment.

FIG. 11 illustrates an overview panel of a collaboration space in which a switching feature is enable for switching a video stream of the selected participant in an individual frame, according to an example embodiment.

FIG. 12 illustrates a user interface that renders a collaboration session according to a customized layout in which a dynamic panel is omitted, according to an example embodiment.

FIGS. 13A and 13B illustrate a first user interface and a second user interface, respectively, generated according to customized layouts in which a dynamic panel includes individual frames for selected collaboration space participants, according to example embodiments.

FIG. 14 illustrates a user interface generated according to a customized layout in which an overview panel is omitted and only an individual views panel is rendered, according to an example embodiment.

FIG. 15 is a flowchart depicting a method of generating a multi-stream of a collaboration space that includes a plurality of video streams, according to an example embodiment.

FIG. 16 is a flowchart depicting a method of rendering a collaboration session on a receiving user device based on a generated layout, according to an example embodiment.

FIG. 17 is a flowchart depicting a method of transmitting a multi-stream that includes a plurality of video streams according to a generated layout, according to one or more example embodiments.

FIG. 18 is a hardware block diagram of a computing device that may perform functions associated with any combination of operations in connection with the techniques depicted in FIGS. 1-12, 13A, 13B, and 14-17, according to various example embodiments.

### DESCRIPTION OF EXAMPLE EMBODIMENTS

### Overview

Methods, devices, and systems are provided that generate a layout for displaying a collaboration space in which an overview panel of a collaboration space along with an individual views panel which has individual frames for remote participants and some of the participants selected in the collaboration space.

In one form, a method is provided that involves obtaining a first multimedia stream of a collaboration space in which at least two participants are physically present in the collaboration space and at least one second multimedia stream of at least one remote participant that is remote from the collaboration space. The at least two participants and the at least one remote participant are collaborating in a collaboration session via user devices. The method further involves selecting one or more participants in the collaboration space and generating a layout for displaying the collaboration session. The layout has an overview panel of the collaboration space and an individual views panel having a plurality of individual frames to display the at least one remote participant and the one or more participants. The method further involves transmitting a multi-stream comprising a plurality of video streams according to the layout for rendering the collaboration session on a respective user device.

### EXAMPLE EMBODIMENTS

Modern video conferencing platforms are popular choices for professional meetings and presentations especially in modern hybrid, remote, and virtual environments. In an online meeting, some participants and/or users (these terms are used interchangeably throughout this description) may be participating via their respective devices that may be geographically remote from each other. The participants and/or users include humans, bots, and/or other non-human entities such as automated computer systems. Some participants may be physically present in a collaboration space such as a meeting room while other participants may be remote from the collaboration space, the so called “remote participants”.

The participant and the respective user (client) device, such as a computer, laptop, tablet, smart phone, etc., may collectively be referred to as endpoints or user devices. The user devices may communicate with each other via one or more networks such as the Internet, virtual private network (VPN), and so on.

The user devices typically have interactive connectivity in a collaboration session. Interactions may include, but are not limited to, manipulating a user interface screen to jump to a particular location, zooming, emphasizing and/or making changes to the actual items and/or objects being displayed such as adding, deleting, and/or editing items and/or objects on the user interface screen, etc.

A collaboration session, an online video conference, or an online meeting (these terms are also used interchangeably herein) typically involves two or more participants being connected via their respective user devices in real-time for collaboration. Some participants may be physically present in a collaboration space while other participant(s) may be remote from the collaboration space.

During a collaboration session, the remote participants are displayed in their respective windows. The audio and/or video of the remote participants are provided in substantially real-time. The collaboration sessions have evolved to further include many artifacts such as transcripts, gestures, reactions, polls, location, chats, voting, screen sharing, whiteboards, etc. For example, a canvas or a whiteboard may be provided during the collaboration session for content sharing and co-editing.

A collaboration session in which some participants are physically present in the collaboration space and others are remote can have challenges. For example, some collaboration platforms attempt to make meeting room participants and remote participants equal in the collaboration session. This has led to use of artificial intelligence (AI) features that may generate a layout in which a meeting room occupies a larger space (window) than in a user interface than that used for individual participants. Doing so allows for meeting room participants to be displayed larger, and therefore closer to being viewed as individual participants in the video layout, especially if adding a so-called frames feature. The frames feature captures up to four participants in the meeting room and displays them in separate individual windows. For example, three remote participants and three participants in the physical meeting room are displayed alongside, each in their individual frame. While this may be a solution when there are few meeting rooms in the collaboration session, and/or when there are few participants in each meeting room, for larger number of participants this solution is impractical.

To provide the above mentioned experience for larger meeting groups/rooms, the collaboration platform would send more than one image/stream from the meeting room. This would create separate video frames for each participant in the meeting room, which can result in crowding the video layout and making it very difficult for remote participants to grasp the context of the meeting. In other words, generating an individual frame for each meeting room participant may result in cognitive overload. Moreover, meeting room participants may move around, switch seats, etc., in the meeting room. A cross view auto selection of a camera angle (front view), as meeting room participants move around, can result in numerous switches of video streams in the video layout, causing confusing, distracting noise, and further contributing to cognitive overload for the remote participant. In other words, while video conferencing technologies may provide features for capturing individuals, these technologies have limitations related to positioning, device capabilities, and platform rendering flexibility, thus making it difficult to avoid cognitive overload in some situations.

To avoid cognitive overload and crowded video layouts, and/or system overload in transmitting a large number of video streams, the techniques presented herein introduce a layout that has an individual views panel that is adjustable on-the-fly, by a respective remote participant, during the collaboration session. The techniques presented herein provide for selecting meeting room participant(s) to view in individual frames and a proximity of the view. That is, the techniques presented herein introduce a new approach for handling video layouts when dealing with multiple videos from meeting room(s). Specifically, users may select one or more participants from the meeting room to view on an individual views panel of the layout. Additionally, alternative view angles for overview shots of the meeting room may be offered.

In one or more example embodiments, an individual frame is a pane, a view, a tile, and/or a window dedicated to displaying a respective participant in their environment (real or virtual background). While one or more example embodiments describe one collaboration space (one meeting room), the description is not limited thereto. Multiple meeting rooms are within a scope of this disclosure and techniques presented herein, such as two meeting rooms, three meeting rooms, etc. The number of participants and/or meeting rooms depend on a particular deployment and use case scenario.

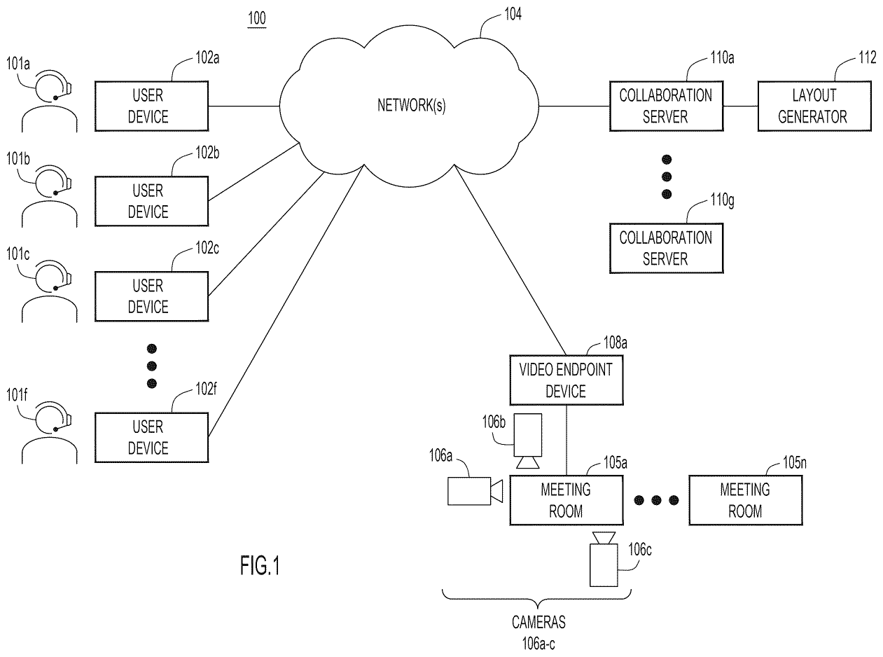

Referring now to FIG. 1, FIG. 1 is a block diagram illustrating an environment 100 in which a layout generator 112 generates a layout for a collaboration session among meeting room participants and remote participants, according to an example embodiment.

The environment 100 includes a plurality of participants 101a-f that participate in a collaboration session using a plurality of user devices (devices) 102a-f that are connected via a network 104 (or a collection of networks) to a plurality of collaboration servers 110a-g. Similarly, in the environment 100, a plurality of meeting rooms 105a-n are each equipped with one or more cameras 106a-c and each participates in the collaboration session via a video endpoint device 108a. The video endpoint device 108a is connected to the plurality of collaboration servers 110a-g via the network 104.

In the environment 100, one or more of the plurality of collaboration servers 110a-g may include a layout generator 112. In one example embodiment, the layout generator 112 may be an external entity or a tool that is not part of the collaboration servers 110a-g. In yet another example embodiment, a layout generator 112 is deployed locally in each video device or a client device in a collaboration session. In yet another example embodiment, the layout generator 112 may be a split service such that layout generator agents are deployed location in video devices e.g., in collaboration spaces, whereas a main layout generator at a collaboration server generates a layout for each client device (remote participant). In short, the deployment of the layout generator 112 depends on a particular scenario and use case.

The notations “a-f”, “a-g”, “a-c”, “a-n”, “a-q”, “a-p”, “a-r”, “a-s”, “a-t” and the like denote that a number is not limited, can vary widely, depends on a particular use case scenario, and need not be the same, in number. Moreover, this is only examples of various collaboration sessions, and the number and types of devices may vary based on a particular deployment and use case scenario.

In the environment 100, one or more users/participants may be participating in a collaboration session (depicted as a first participant 101a, a second participant 101b, a third participant 101c, and a fourth participant 101f). The participants 101a-f use their respective devices 102a-f (depicted as a first user device 102a, a second user device 102b, a third user device 102c, and a fourth user device 102f) to participate in a collaboration session. The participants 101a-f are examples of remote participants that join a collaboration session from a remote location. The participants 101a-f are remote from a collaboration space (e.g., one of the meeting rooms 105a-n).

The devices 102a-f as well as other entities in the environment 100 (the video endpoint device 108a, and the collaboration services 110a-g) communicate with each other via the network 104. The network 104 may include a local area network (LAN), a wide area network (WAN) such as the Internet, or a combination thereof, and includes wired, wireless, or fiber optic connections. In general, the network 104 can use any combination of connections and protocols that support communications between the entities of the environment 100.

The meeting rooms 105a-n such as a first meeting room 105a and a second meeting room 105n, are examples of a physical collaboration space in which at least two participants are physically present. In other words, the first meeting room 105a and the second meeting room 105n may be conference rooms or some other physical area or space in which multiple participants collaborate with one another. To further collaborate with the participants 101a-f (remote participants), the meeting rooms 105a-n may be equipped with video conferencing equipment such as camera(s), microphone(s), speaker(s), user device(s), etc. The number and type of video conferencing equipment is not limited to the examples in FIG. 1, and will vary depending on a particular deployment and use case scenario. By way of an example, the first meeting room 105a includes video cameras 106a-c such a front view camera 106a, a first side view camera 106b, and a second side view camera 106c. The video cameras 106a-c are configured to capture video for multiple views of the first meeting room 105a. One or more of the cameras 106a-c may be integrated with or connected to the video endpoint device 108a.

The video endpoint device 108a is an example of a user device that is configured to connect multiple participants in the first meeting room 105a to the collaboration session. The video endpoint device 108a may be a computing device that performs the video encoding and decoding functions for outbound video from the meeting room 105a and inbound video to the meeting room 105a. The video endpoint device 108a is often referred to in the industry as the “codec”. The video endpoint device 108a may be configured to identify each meeting room participant, select best view (e.g., front view) for each participant, etc., display remote participants, display shared content, etc. In short, the meeting room participants collaborate with remote participants in the collaboration session using the video endpoint device 108a. The video endpoint device 108a provides a multi-stream that includes a plurality of video streams to one of the collaboration servers 110a-g via the network 104.

The collaboration servers 110a-g (depicted as a first collaboration server 110a and a second collaboration server 110g) manage and control collaboration sessions. The devices 102a-f and the video endpoint device 108a communicate with the collaboration servers 110a-g to join and participate in the collaboration session. The collaboration servers 110a-g retrieve and control distribution of various content from databases (not shown) and media streams of the collaboration session to the devices 102a-f and the video endpoint device 108a.

The collaboration servers 110a-g further store identifiers of various collaboration sessions that may be obtained from the databases (one or more memories or datastores). The collaboration servers 110a-g are configured to communicate with various client applications executing on the devices 102a-f and the video endpoint device 108a. The client applications running on the devices 102a-f and the video endpoint device 108a detect various actions performed by the respective participants during a collaboration session and notify the respective collaboration server associated with the collaboration session about these events. The respective collaboration server may generate video data to render or display, in a collaboration space and/or on a user interface screen of the respective device, content of the collaboration session. That is, one of the collaboration servers 104a-g sends commands to the client applications running on the devices 102a-f to render content in a particular way, to change views, controls, and so on. This is just an example, in some use case, how to render content may be controlled locally on the devices 102a-f or in combination with one of the collaboration servers 104a-g.

One of the collaboration servers 104a-g may capture participant actions (selection of meeting room participant(s), setting of a selection criteria, etc.) during the collaboration session and provide to the layout generator 112. In short, the collaboration servers 104a-g control the collaboration sessions by communicating and/or interacting with client applications running on the devices 102a-f and the video endpoint device 108a that detect various actions performed by the participants 101a-f during the collaboration sessions and execute commands and/or instructions for the collaboration sessions as provided by the collaboration servers 104a-g.

In one or more example embodiments, the collaboration servers 104a-g further communicate with the layout generator 112 via the network 104. The collaboration servers 104a-g provide, to the layout generator 112, various data such as a plurality of multimedia streams of an ongoing collaboration session and content shared during the collaboration session. The multimedia streams may include a first multimedia stream of a collaboration space in which at least two participants are physically present in the collaboration space (e.g., the first meeting room 105a) and second multimedia streams from the remote participants (e.g., the participants 101a-f) that are remote from the first meeting room 105a. These are just some non-limiting examples of various multimedia streams that may be provided to the layout generator 112 during an established or an ongoing collaboration session.

In one example embodiment, there may be multiple first multimedia streams (e.g., from the first meeting room 105a and the second meeting room 105n) and one or more of the second multimedia streams. The number of multimedia streams depend on a type of deployment and use case scenario. Initially, the video endpoint device 108a may send one or more default streams, such as a room view and a view of the current active speaker. In addition, the video endpoint device 108a may provide metadata to other clients/devices (the devices 102a-f) about other available streams. If the other devices/clients in the collaboration session request a specific stream that is currently not being sent, the video endpoint device 108a starts sending the requested stream to one of the collaboration servers 110a-g, which then transmits the specific stream to the requesting devices/clients. As such, network load may be reduced by only providing requested streams when needed and/or only to the requesters.

Additionally, the collaboration servers 104a-g may monitor activities occurring in collaboration sessions. These activities may involve in-meeting commands and/or reactions from one or more participants 101a-f via respective devices 102a-f and meeting room participants in the first meeting room 105a via the video endpoint device 108a. In-meeting commands may involve a selection of the one or more participants in the first meeting room 105a for generating an individual frame for each selected participant, a selection of a specific frame for removing the specific frame with the selected participant, manipulating one or more icons in the displayed collaboration session for switching participants, etc. In-meeting commands may involve interactions with shared content. Reactions relates to the participant's engagement activities such as facial expressions, audio phrases, emojis, chat comments, etc.

The collaboration servers 104a-g may adjust the ongoing collaboration sessions based on the in-meeting commands and provide the in-meeting commands to the layout generator 112 along with the multimedia streams of the collaboration session.

The layout generator 112 generates layouts for displaying the collaboration session on the devices 102a-f and/or the video endpoint device 108a. That is, based on in-meeting commands and/or a selection criteria set by a respective participant (e.g., one of the participants 101a-f) prior to the collaboration session, the layout generator 112 generates the layout having an overview panel of the first meeting room 105a and an individual views panel having individual frames for the remote participants and selected meeting room participants. The individual frames for the selected meeting room participants are based on in-meeting commands and/or the set selection criteria. The individual frames for the selected meeting room participants may be dynamically adjusted, on-the-fly, during the collaboration session, based on the additional input from the respective participant (changing the selection criteria and/or in-meeting commands). Specifically, individual frames may be added, removed, or participants displayed therein may be switched, as detailed below. The layout generator 112 may generate a custom layout specific to each remote participant based on their selections and selection criteria.

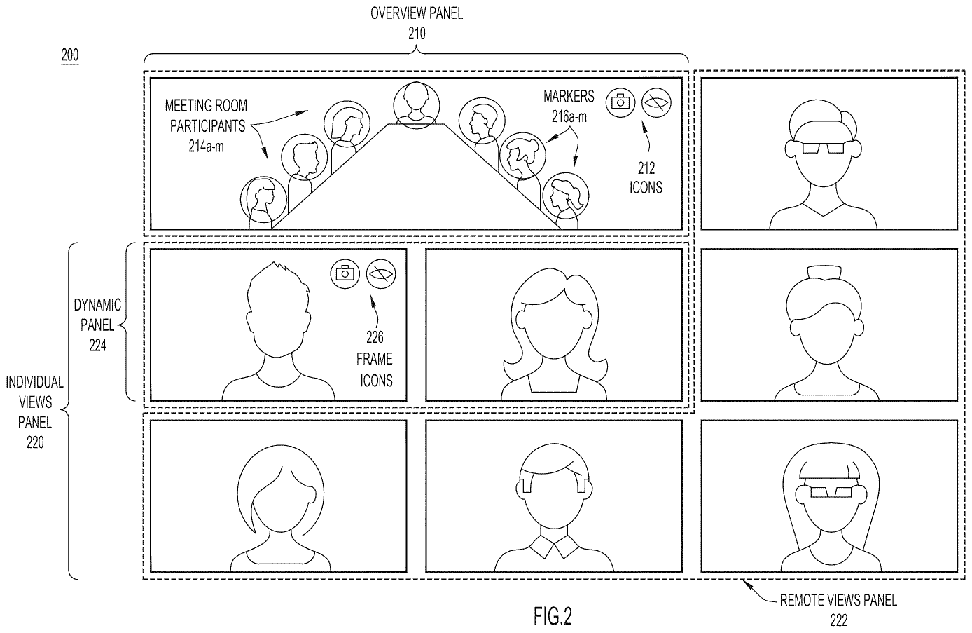

With continued reference to FIG. 1, FIG. 2 illustrates a layout 200 for displaying a collaboration session in which some participants are physically present in a collaboration space while others are remote from the collaboration space, according to an example embodiment. The layout 200 includes an overview panel 210 and an individual views panel 220 having a remote views panel 222 and a dynamic panel 224. The layout 200 may be generated by the layout generator 112 of FIG. 1.

In one example embodiment, the layout 200 may be generated based on input selection(s) by the first participant 101a via the first user device 102a, and as a result of the input selection(s), a multi-stream of the plurality of video streams according to the layout 200 may be transmitted to the first user device 102a for rending the collaboration session to the first participant 101a.

The overview panel 210 is configured for depicting a collaboration space or a meeting room (e.g., the first meeting room 105a). While the layout 200 includes only one overview panel, this is not meant to be limiting. If a collaboration session involves two or more meeting rooms, an overview panel for each meeting room may be generated.

While the overview panel 210 is generated based on a multimedia stream from the front view camera 106a (i.e., main camera), this is just an example. The overview panel 210 may be generated based on multimedia stream(s) from one or more cameras in the first meeting room 105a. The overview panel 210 provides an overview picture of the meeting room participants 214a-m in the first meeting room 105a.

In one example embodiment, the overview panel 210 includes a plurality of icons 212 for performing in-meeting commands (meeting room participant selection(s), manipulating the overview panel 210 such as changing the location in the layout 200, changing the size, changing the camera view, and/or removing the overview panel 210 from the layout 200, etc.). For example, by activating a meeting room participant selection feature, the meeting room participants 214a-m may be displayed with markers 216a-m, shown as circles.

The individual views panel 220 shows one or more video panes (a plurality of individual frames, tiles, windows, panes, etc.), each depicting an individual participant. The individual views panel 220 includes a remote views panel 222 and a dynamic panel 224, thus integrating individual views of selected participants in the meeting room with individual views of remote participants.

Specifically, the remote views panel 222 displays individual frames for the remote participants (e.g., the participants 101a-f). The remote views panel 222 may be considered a static portion of the individual views panel 220, which is visually integrated with the dynamic panel 224.

The dynamic panel 224 varies the number of individual frames based on user input and selection settings or criteria. That is, the dynamic panel 224 displays individual frames for selected meeting room participants (one or more selected participants in the first meeting room 105a). Additionally, dynamic panel 224 varies the view of the selected participant. The multimedia stream of the participant to be displayed is selected from a first video source, a second video source, or a third video source (cameras 106a-c) depending on which video source shows the best view of the selected participant.

As an example, the user may activate a pinning (selection) feature in a user experience (UX) or a user interface (UI) screen/window by manipulating one of the plurality of icons 212 in the overview panel 210. In response to activating the selection feature, the overview panel 210 displays markers 216a-m on the individual meeting room participants 214a-m in the first meeting room 105a. The user may then select one or more participants using the displayed markers 216a-m. Based on user input, new individual frames or video panes of the selected participants are generated and rendered in the dynamic panel 224. The user may add as many new individual frames as there are participants 214a-m in the first meeting room 105a, remove individual frames from the dynamic panel 224, and switch selected participants (select a different participant to be shown in an already added new individual frame) by manipulating one of the frame icons 226. The dynamic panel 224 is integrated with the remote views panel 222, forming the individual views panel 220.

### A) Collaboration Space Processing

With continued reference to FIGS. 1 and 2, FIG. 3 is a diagram depicting a method 300 of generating a multi-stream of a plurality of video streams from a collaboration space, according to an example embodiment. The method 300 may be performed by one or more devices in the collaboration space 302 such as a main camera 304, a side camera 306, and a codec device 308 (e.g., the video endpoint device 108a of FIG. 1).

Specifically, the method 300 involves at 312, the main camera 304 capturing a front view 310 a of the collaboration space 302 and at 314, the side camera 306 capturing a side view 310b of the collaboration space 302. The front view 310a shows meeting room participants from a main wall in the collaboration space 302. As an example, the main wall in the collaboration space may be in the front of the room and includes a whiteboard, a screen, etc. The side view 310b shows meeting participants on the opposite side of the side camera 306 facing forward. The side view 310b is captured from side walls, tables, etc. By having different views, face forward capture of the meeting room participants may be accomplished.

The captured multimedia streams are then provided to the codec device 308. Specifically, at 316, the front view 310a is provided from the main camera 304 to the codec device 308 and at 318, the side view 310b is provided from the side camera 306 to the codec device 308. The codec device 308 processes the received multimedia streams.

Specifically, the codec device 308 detects each meeting room participant based on the front view 310a and the side view 310b. The codec device 308 then determines a face forward view for each identified meeting room participant. The codec device 308 selects one of the views in which a respective meeting room participant is facing forward. Each view is then processed to include the respective meeting room participant such as their head and part of the shoulders.

For example, the codec device 308 may include a head detection system that pinpoints a location of each meeting room participant in the collaboration space based on x, y, z distance from the main camera 304 and the side camera 306. This location information is cross referenced among the cameras in the collaboration space 302 (the cameras are calibrated before the collaboration session and their locations are known).

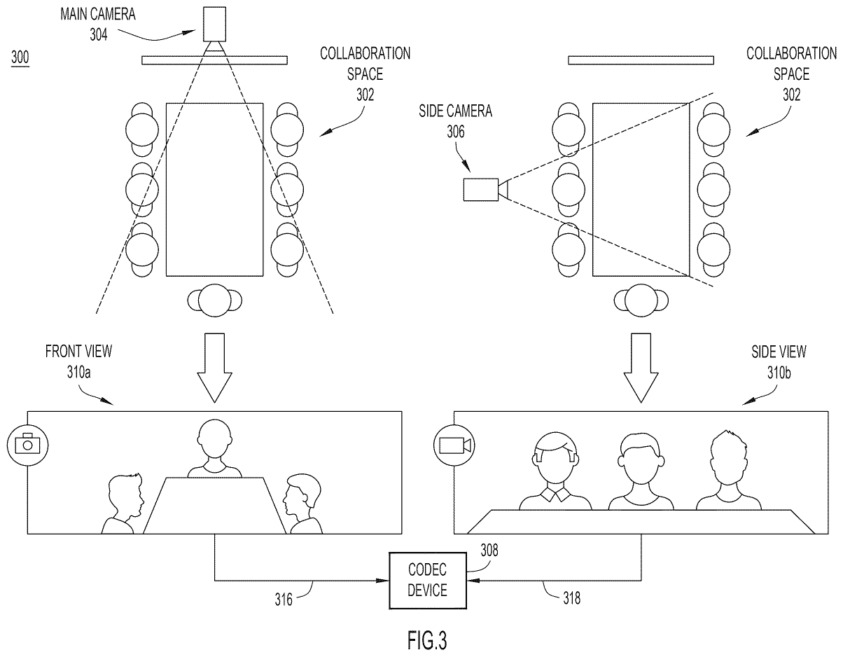

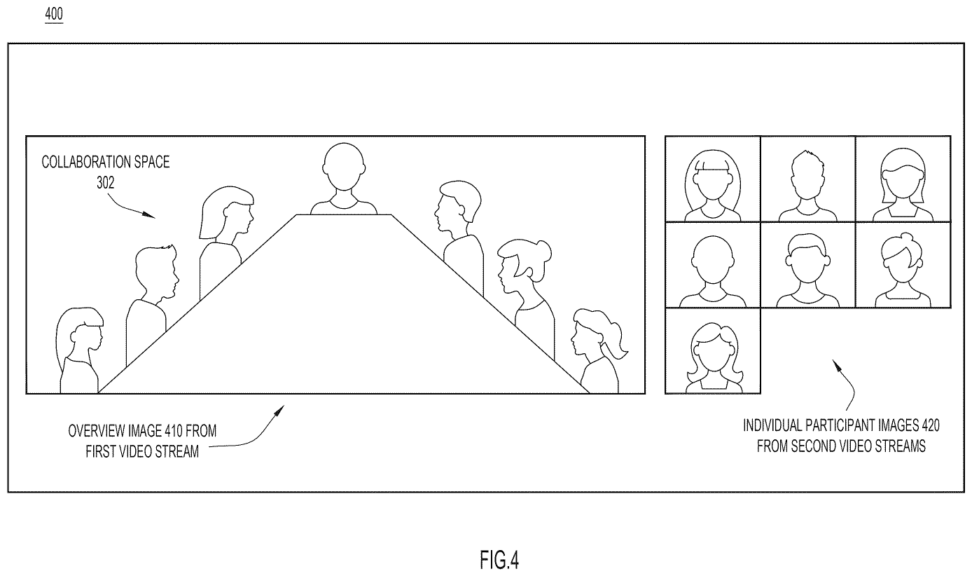

With continued reference to FIGS. 1-3, FIG. 4 illustrates rendering of images 400 from a multi-stream which includes a plurality of video streams generated by the codec device 308 of FIG. 3, according to an example embodiment. The images 400 include an overview image 410 and individual participant images 420 generated based on the multi-stream.

Specifically, the multi-stream includes a first video stream that provides the overview image 410 of the collaboration space 302 from the main camera 304. The overview image 410 includes a view of the collaboration space with the meeting room participants.

The multi-stream further includes individual streams (second video streams), which provide individual participant images 420. Specifically, the codec device 308 generates one stream for each detected meeting room participant from the plurality of meeting room participants. Additionally, the codec device 308 selects a best view for each individual meeting room participant.

The codec device 308 generates a multi-stream that may then be transmitted to one of the collaboration servers 110a-g (the layout generator 112). In one or more example embodiments, the codec device 308 may continuously provide the multi-stream for rendering the images 400. However, in one example embodiment, the codec device 308 may limit the individual streams based on a selection criteria and/or an in-meeting command.

### B) Processing for Receiving User Device(s)

With continued reference to FIGS. 1-4, FIG. 5 is a diagram depicting a method 500 of providing a multi-stream that includes a plurality of video streams according to a generated layout for rending the collaboration session on a receiving user device, according to an example embodiment. The method 500 involves a collaboration space 510 having a main camera 512, side cameras 514a-d, and the codec device 308 of FIG. 3. The method 500 further involves the first collaboration server 110a having the layout generator 112 and a receiving user device 520 (one of the user devices 102a-f of FIG. 1).

The method 500 involves at 530, the codec device 308 receiving video streams from the main camera 512 and the side cameras 514a-d (such as a first side camera 514a, a second side camera 514b, a third side camera 514c, and a fourth side camera 514d).

At 532, the codec device 308 transmits a multi-stream to the first collaboration server 110a. The codec device 308 initially transmits only some default streams, such as the room overview and a couple of streams with recent and active speakers. That is, the codec device transmits only streams that are actually displayed at one of the remote sites in the collaboration session to the first collaboration server 110a. If a remote device/client (the receiving user device 520) requests an additional stream, the codec device 308 will then transmit that additional stream. If the layout generator 112 is deployed at the receiver device/client, the requests for a specific stream are transmitted via the collaboration server. In one example embodiment, the multi-stream includes a plurality of video streams including an overview image and an individual image (stream) per meeting room participant.

Additionally, the first collaboration server 110a obtains a video stream from each remote participant (not shown). When the first collaboration server 110a obtains a multi-stream from one location (detected codes), the first collaboration server 110a initiates the layout generator 112. In one example embodiment, the layout generator 112 may limit the received streams from one location (Internet Protocol (IP)/location code on the server) to two streams/tiles to prevent slow loading, re-shuffling, and in the end cognitive load for the receiver. In other words, the number of video streams that may be included in the multi-stream depends on a particular deployment and use case scenario.

The method 500 further involves the layout generator 112 obtaining user input. For example, at 534, the layout generator 112 receives an in-meeting command, a selection, or collaboration session settings from the receiving user device 520. This is provided by way of an example only. In one example embodiment, the operation 534 may be omitted and the layout generator 112 may use a default selection criteria set at the layout generator 112 for generating custom layouts. The layout generator 112 generates a layout for displaying video streams obtained by first collaboration server 110a.

The generated layout is to be rendered locally at the receiving user device 520. Specifically, at 536, the first collaboration server 110a transmits the multi-stream that includes a plurality of video streams according to the generated layout for rendering the collaboration session on the receiving user device 520.

As an example, content for the collaboration session rendered according to the generated layout includes an overview panel 540 of the collaboration space such as a first tile/area for displaying a video stream of the entire meeting room and an individual views panel 542. The individual views panel 542 includes a dynamic tile/area for displaying one or more video streams of selected meeting room participants from within the overview panel 540 and a static tile/area having for displaying video streams of remote individual participants.

This is just an example and it should be understood that the layout may specify multiple overview panels (one for each meeting room) with the individual views panel 542 including several dynamic areas with respective meeting room selected participants. The selected participants individual frames may spatially correspond to the locations of these participants in the respective meeting room.

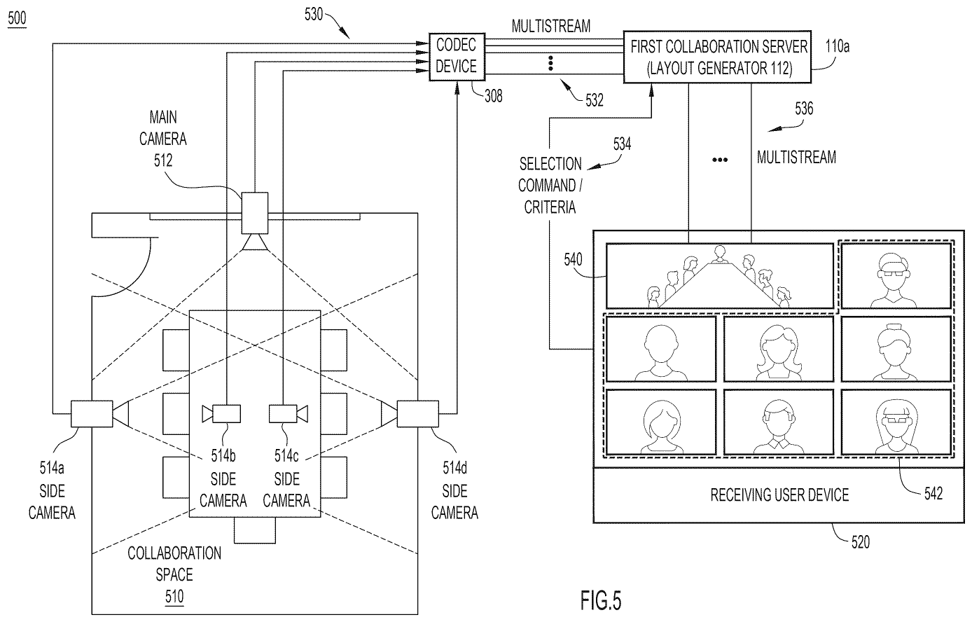

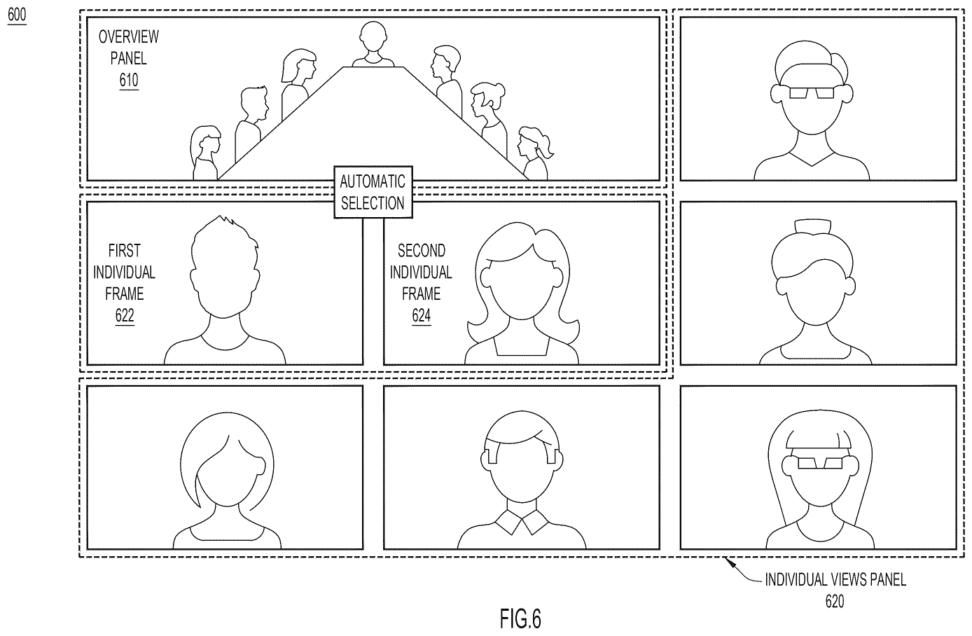

With continued reference to FIGS. 1-5, FIG. 6 illustrates a layout 600 for displaying a collaboration session in which selected participants that are physically present in collaboration space are displayed in individual frames, according to an example embodiment. The layout generator 112 of FIGS. 1 and 5 may generate the layout 600. The layout 600 includes an overview panel 610 and individual views panel 620 having a first individual frame 622 and a second individual frame 624 selected from the overview panel 610.

Specifically, the layout generator 112 may detect each participant in the collaboration space and selected one or more participants based on a preset selection criteria. For example, the layout generator 112 may select participants based on their type. A participant type may involve customer participant type, developer participant type, users of an enterprise A, service provider participant type, etc. As another example, the layout generator 112 may select participants based on participant actions. Participant actions may involve audio activity (active speakers), body and facial language, participant movements (intending to highlight the action), etc.

By monitoring participants in the collaboration space and automatically selecting the one or more participants based on the selection criteria, the layout generator 112 generates the first individual frame 622 and the second individual frame 624 for most active speakers in the collaboration space. Additionally, the selection criteria may set a maximum number of individual frames of meeting room participants e.g., two, three, four, etc., to prevent cognitive overload for the receiving user device 520 of FIG. 5. As such, only two video streams are rendered in the layout 600. Other video streams (best view of each individual meeting room participant) are hidden in the background. In one or more example embodiments, an initial selection of views may be performed by the sending device based on a local selection criteria, or a selection criteria shared in the collaboration session by the participating user devices, and the receiving device initially renders these views in the layout.

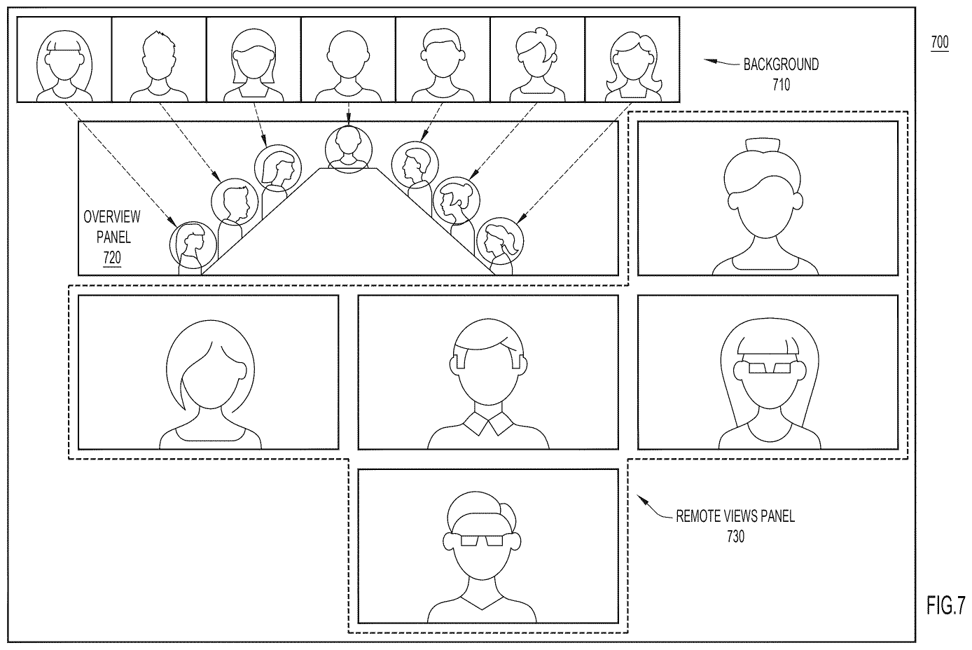

With continued reference to FIGS. 1-6, FIG. 7 illustrates rendered and hidden images 700 of video streams in a multi-stream of a collaboration session, according to an example embodiment. The rendered and hidden images 700 include video streams hidden in a background 710, a video stream of a collaboration space (an overview panel 720), and video streams of remote participants (a remote views panel 730).

The layout generator 112 obtains a best view of each individual collaboration space participant from the codec device 308 of FIGS. 3 and 5. These video streams are hidden in the background 710. As an alternative, instead of hiding streams in the background 710, the sending device transmits metadata about available streams, and the available streams are only transmitted to a respective collaboration server, and further to the receiver device/client when requested. As such, network load is reduced. In any event, since a multi-stream transmitted from the collaboration space, via the codec device 308, includes individual video streams of each participant, at least some of these video streams are hidden from view by the layout generator 112. Based on a generated layout, the receiving user device 520 renders the collaboration session with the overview panel 720 that displays the collaboration space and a remote views panel 730 that displays individual frames of the remote participants. The rendered collaboration space may be displayed in a wide view panel compared to individual frames of remote participants (size of two, three individual view frames, etc.).

A user of the receiving user device 520 may select to view one or more meeting room participants that do not show up/appear close in the collaboration space. Based on user input, a closer view of meeting room participants may be added in individual frames. Each remote participant may select which individual to view up close from the collaboration space in their respective collaboration sessions. For example, a user may select meeting room participants by setting selection criteria, such as a participant type and/or actions of the participant or by issuing in-meeting command(s). Based on the foregoing, one or more images hidden in the background 710 may be displayed in new individual frames in a rendered collaboration session. As such, remote participants may view one or more meeting room participants in separate individual frames.

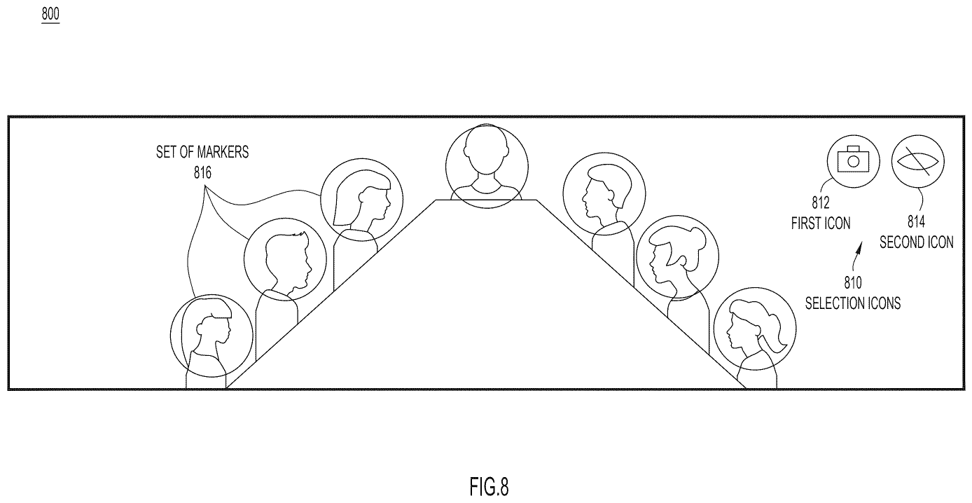

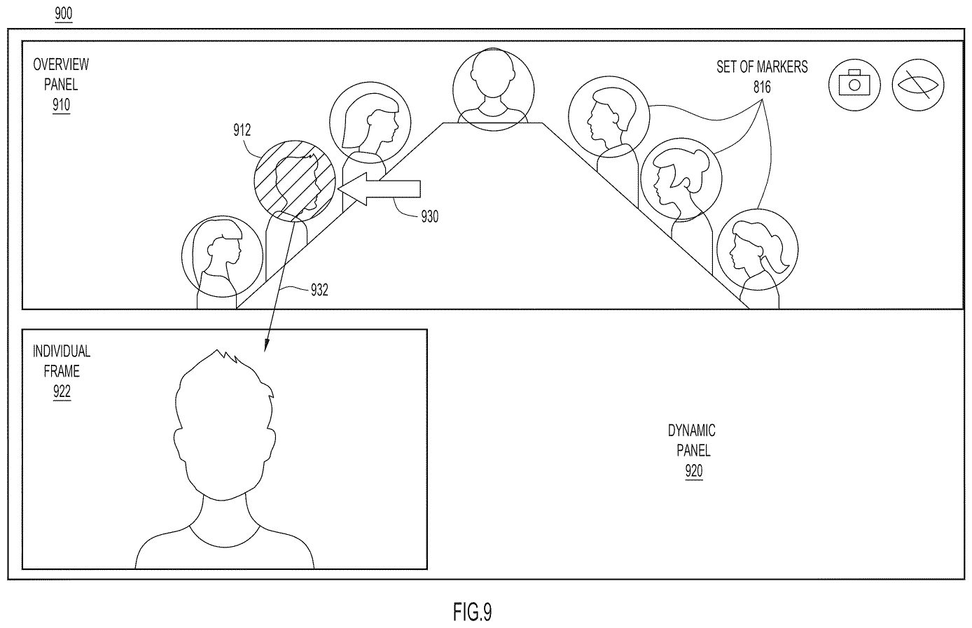

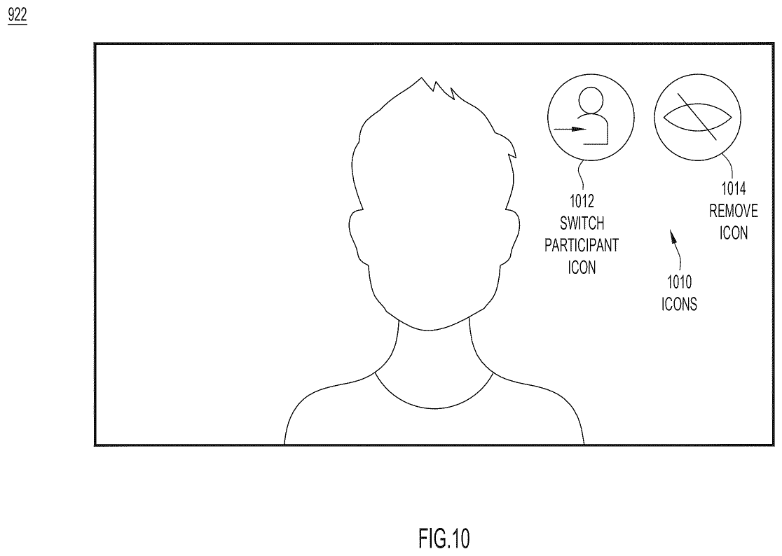

FIGS. 8-11 are diagrams illustrating selecting one or more participants from a collaboration space for viewing in individual frames, according to one or more example embodiments. The layout generator 112 generates custom layouts specific to remote participants based on their respective selections.

Participants or users may change who to view in the individual views panel, or remove the added individual frame(s) from the layout at any time. For example, selection icons or buttons may be provided next to a participant's name in the list or in the individual frame after selecting or clicking on a respective participant. The layout generator 112 enables a user interface to initiate adding and/or changing displayed individual frames in the individual views panel via icons, buttons, or other user interface features for activating a pinning or selection process.

These buttons or icons may be displayed in an overview panel in response to tapping or clicking, via a respective user device, on a displayed collaboration space in the overview panel, or within the layout settings on a navigator unit in meeting room endpoints. This is provided by way of an example only and not way of a limitation, audio or gesture commands are within the scope of this description.

Specifically, FIG. 8 illustrates an overview panel 800 for enabling a layout generator to generate a custom layout specific to a respective participant, according to an example embodiment. The overview panel 800 includes selection icons 810 and a set of markers 816 for enabling the layout generator 112 to generate custom layouts.

The selection icons 810 may include a first icon 812 for enabling and disabling selection of individual participants in the overview panel 800 and a second icon 814 for removing the overview panel 800 from the rendered collaboration session.

Based on enabling the selection of individual participants in the collaboration space by manipulating the first icon 812 (clicking a button), the overview panel 800 updates with the set of markers 816. A marker is provided for each detected participant in the video stream of a meeting room overview visualization on the navigator. The layout generator 112 generates the set of markers 816 based on head detection and face location in relation to the main camera position. This information (metadata) is sent from the collaboration space (the codec device 308) along with the imagery to the layout generator 112 in the first collaboration server 110a. On the receiver side, the receiving user device 520 locally renders the set of markers 816 over the overview panel 800 (overview visualization or navigator).

While the set of markers 816 are depicted as circles in the overview panel 800, this is just an example. The set of markers 816 may be next to a participant name in a list of participants, may be in a form of a hyperlinked name in the list of participants, may be another symbol or an alphanumeric designation. The description includes other types of indicators for the detected participants in the overview panel 800 and is not limited to these examples.

With continued reference to FIGS. 1-8, FIG. 9 is a diagram depicting a method 900 of generating, by the layout generator 112, an individual frame in a dynamic panel based on a selection of a participant in a collaboration space, according to an example embodiment. The method 900 involves an overview panel 910 in which the selection or pinning feature is enabled, explained in FIG. 8. In the overview panel 910, the set of markers 816 are displayed for selecting one or more participants. The method 900 further involves a dynamic panel 920 of the individual views panel in which individual frames may be added, removed, or participants depicted therein switched. As an example, an individual frame 922 (new frame) is being added to the dynamic panel 920.

In the method 900, at 930, the layout generator 112 obtains a selection of a participant in the collaboration space from a user. By clicking on a respective marker 912 in the set of markers 816, the user selects a participant to be additionally displayed in a new individual frame in the dynamic panel 920.

At 932, the layout generator 112 generates the individual frame 922 for the selected participant. The layout generator 112 further updates the dynamic panel 920 to display the video stream of the selected participant in the individual frame 922.

With continued reference to FIGS. 1-9, FIG. 10 illustrates the individual frame 922 in the dynamic panel 920 in which features for adjusting the dynamic panel are enabled, according to an example embodiment. Specifically, the individual frame 922 includes icons 1010 for adjusting the dynamic panel by switching the participants in the individual frame 922 or removing the individual frame 922.

In particular, the icons 1010 include a switch participant icon 1012 and a remove icon 1014. The user may change the selection by either exchanging the selected participant with another participant from the collaboration space by manipulating the switch participant icon 1012 or by removing the added tile of the selected participant (the individual frame 922), by manipulating the remove icon 1014. When the remove icon 1014 is selected, the individual frame 922 is unpinned and removed from the dynamic panel.

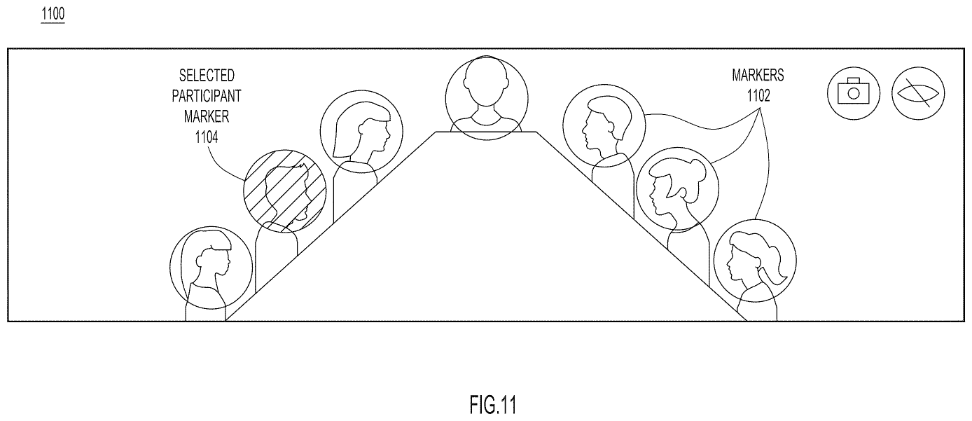

On the other hand, when clicking the switch participant icon 1012, the overview panel is updated for further selections, as shown in FIG. 11.

With continued reference to FIGS. 1-10, FIG. 11 illustrates an overview panel 1100 of a collaboration space in which a switching feature is enabled for switching a video stream of the selected participant in an individual frame, according to an example embodiment.

The overview panel 1100 is updated with markers 1102. That is, markers 1102 reappear on the room overview image/visualization on the navigator. Additionally, a selected participant marker 1104 depicts the currently selected participant rendered in the individual frame 922. By selecting a desired different participant via the markers 1102, the video stream of the newly selected participant replaces the video stream of the currently selected participant rendered in the individual frame 922.

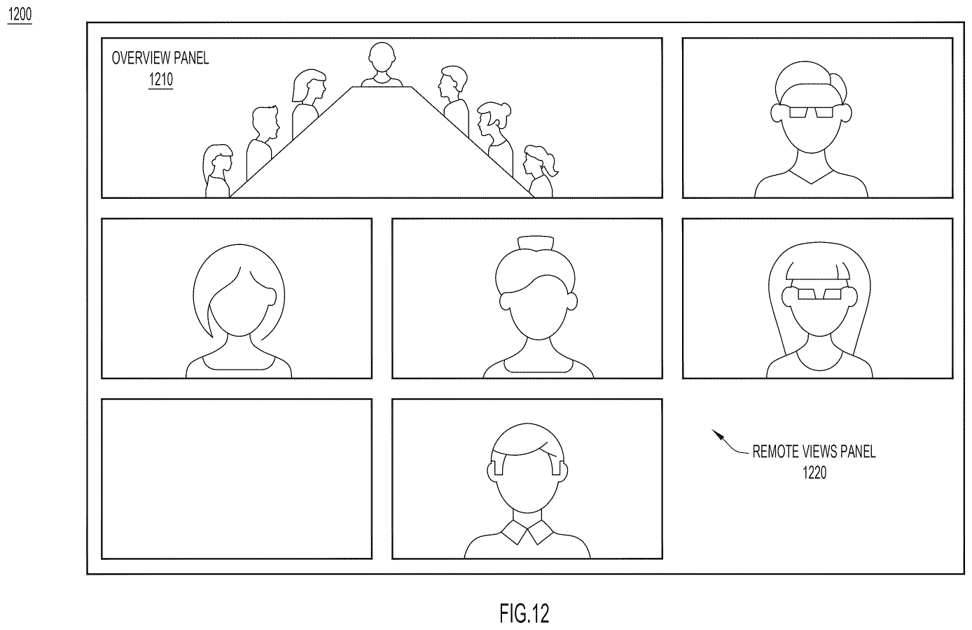

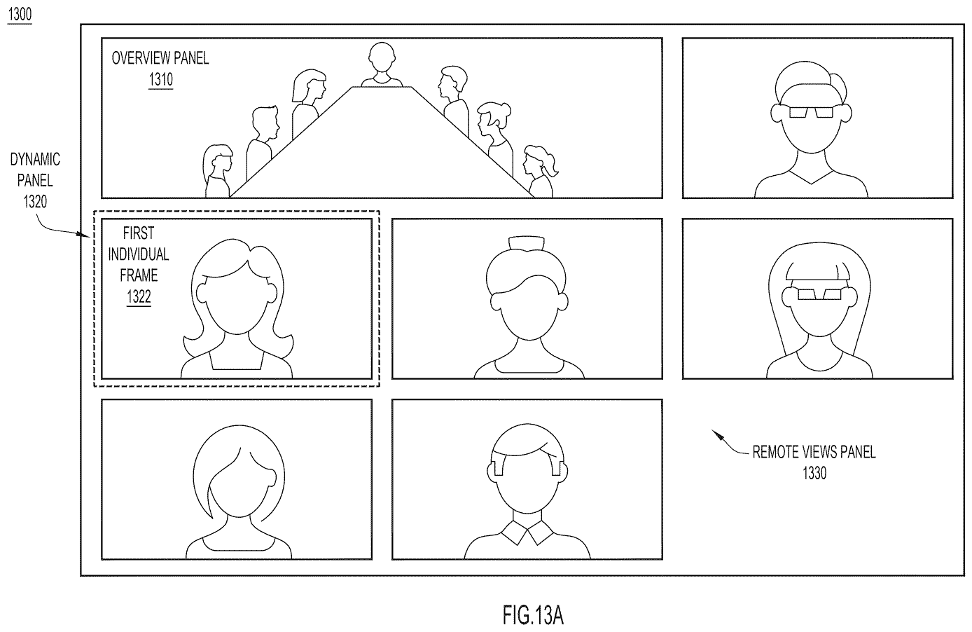

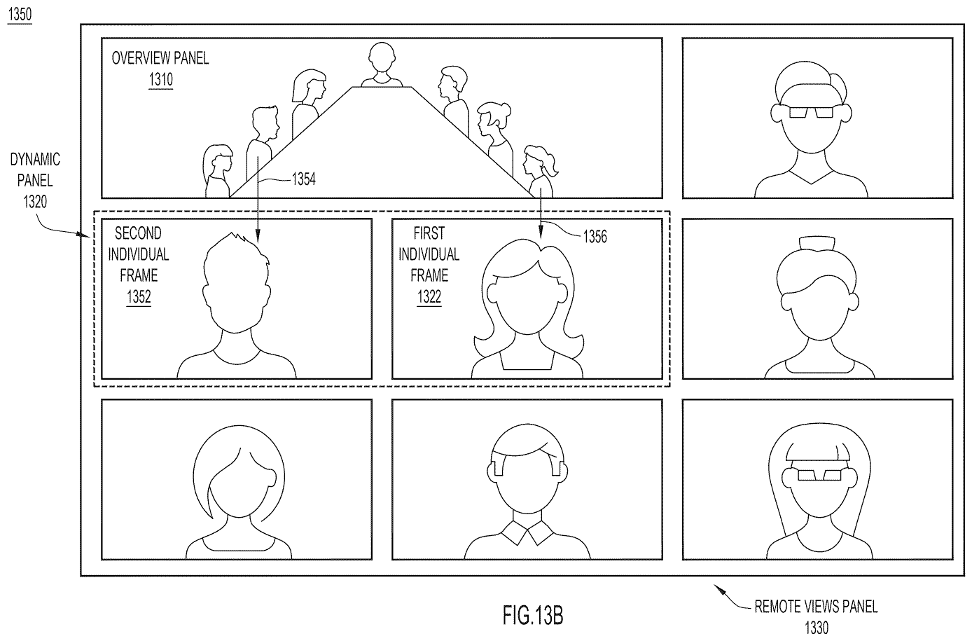

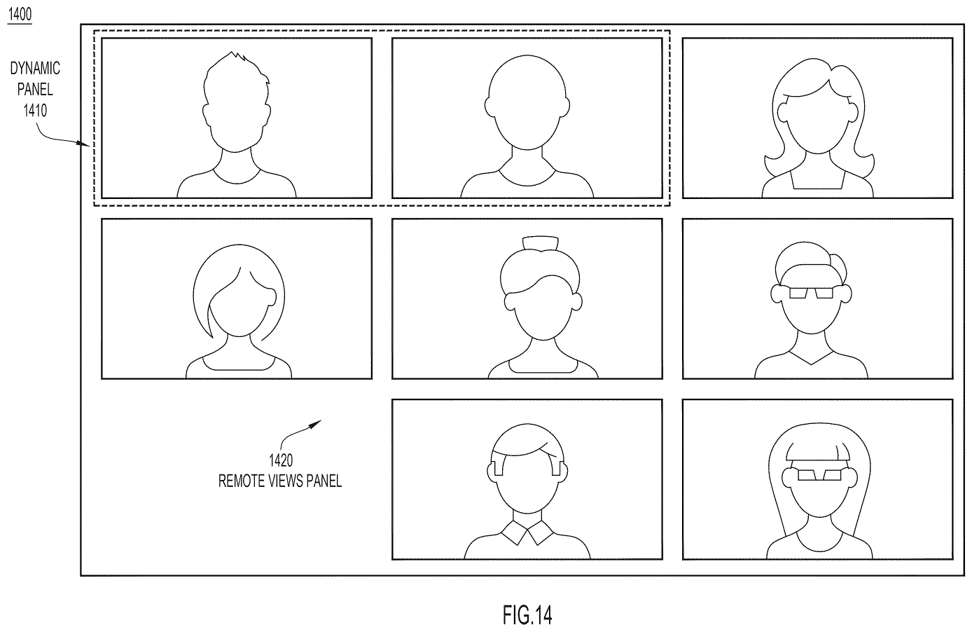

This flexibility allows users to customize whom from the collaboration space they would like to view in the collaboration session. FIGS. 12, 13A, 13B, and 14 illustrate user interfaces for rendering a collaboration session based on different users selections, according to one or more example embodiments.

Specifically, with continued reference to FIGS. 1-11, FIG. 12 illustrates a user interface 1200 that renders a collaboration session according to a customized layout in which a dynamic panel is omitted, according to an example embodiment. The user interface 1200 excludes a dynamic panel and only includes video streams for the overview panel 1210 and video streams for a remote views panel 1220 in which remote participants are displayed in individual frames. None of the participants in the collaboration space are displayed in individual frames.

With continued reference to FIGS. 1-11, FIGS. 13A and 13B illustrate a first user interface 1300 and a second user interface 1350, respectively, generated according to customized layouts in which a dynamic panel includes individual frames for selected collaboration space participants, according to example embodiments.

The first user interface 1300 and the second user interface 1350 include an overview panel 1310 of the collaboration space, individual frames for selected participant(s) in a dynamic panel 1320, and individual frames for the remote participants in a remote views panel 1330. While the video stream of the collaboration space and the remote participants remain static, video streams rendered in the dynamic panel 1320 are adjusted.

For example, in the first user interface 1300, an individual frame or tile for the most active participant in the collaboration space is rendered. Specifically, the selection criteria may be set to select most active participant(s) in the collaboration space based on their actions such as speaking, sharing content, making edits to the shared content (movements), etc. Accordingly, the dynamic panel 1320 includes a first individual frame 1322 for a first active participant (main active speaker) in the collaboration space. This is provided by way of an example only.

The selection criteria may also specify the number of active participants to display in the dynamic panel 1320. For example, individual frames may be generated for second and third active participants (that ask questions and/or provide feedback) in the collaboration space. In the dynamic panel 1320, the individual frames are positioned at locations that spatially correspond to locations of the selected participants in the collaboration space.

In addition to the selection criteria, a remote participant may use in-meeting commands e.g., by manipulating icons, to select participants in the collaboration space to be rendered in the dynamic panel 1320. The second user interface 1350 includes the first individual frame 1322 of the most active participant in the collaboration space selected based on a set selection criteria and a second individual frame 1352 in which a video stream of a selected participant is displayed. In other words, the dynamic panel 1320 includes both, a meeting room participant selected based on a selection criteria and a meeting room participant selected via a remote user command.

In the dynamic panel 1320, the individual frames are positioned at locations that spatially correspond to locations of the selected participants in the collaboration space. Specifically, the first individual frame 1322 is positioned on the right hand side of the dynamic panel 1320 and the second individual frame 1352 is positioned on the left hand side of the dynamic panel 1320, which spatially correspond to locations of the selected participants in the collaboration space displayed in the overview panel 1310, shown at 1354 and 1356. By spatially aligning positioning of the individual frames to the locations of the participants in the overview panel 1310, it is easier for the user to grasp the context, and confusion and cognitive overload can therefore be avoided or minimized.

With continued reference to FIGS. 1-11, FIG. 14 illustrates a user interface 1400 generated according to a customized layout in which an overview panel is omitted and only individual views panel is rendered, according to an example embodiment. The user interface 1400 includes a dynamic panel 1410 and a remote views panel 1420.

In the dynamic panel 1410, individual frames for video streams of selected participants in the collaboration space are provided. While overview panel is omitted and not displayed in the user interface 1400, the positioning of the individual frames of the selected participants spatially correspond to the locations of these selected participants in the collaboration space. In the user interface 1400, the user views only the closeup of selected participants from the collaboration space and not the overview image of the collaboration space. The overview panel may be recalled at any time for example, via a button that may appear on any of the individual frames in the dynamic panel 1410 or as a separate entry point.

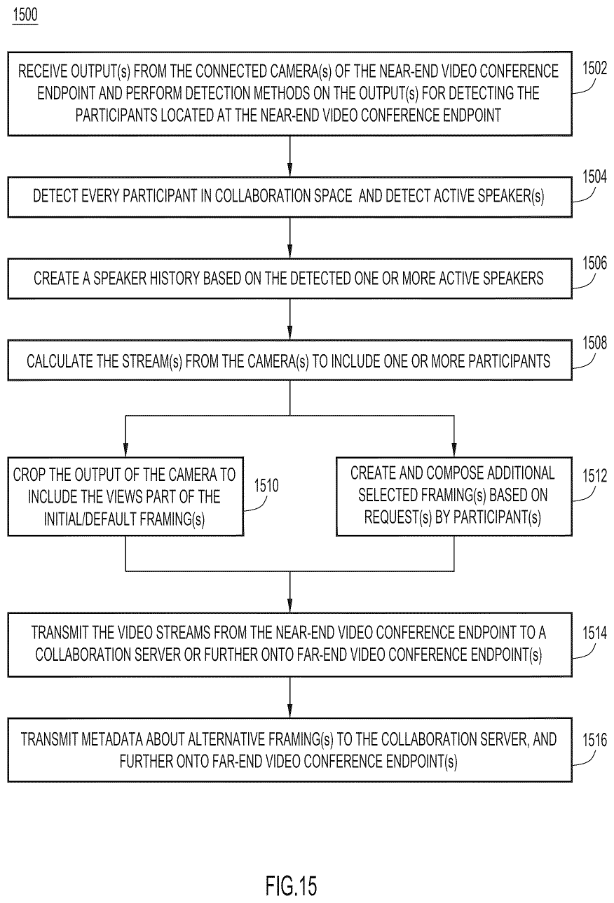

With continued reference to FIGS. 1-12, 13A, 13B, and 14, FIG. 15 is a flowchart for a method 1500 of generating a multi-stream of a collaboration space that includes a plurality of video streams, according to an example embodiment. The method 1500 may be performed by a near-end video conference endpoint such as the video endpoint device 108a of FIG. 1 or the codec device 308 of FIGS. 3 and 5. The method 1500 is an example of collaboration space processing for rendering a collaboration session at a receiver or a far-end video conference endpoints such as one of the devices 102a-f of FIG. 1 or the receiving user device 520 of FIG. 5.

The method 1500 involves at 1502, receiving output(s) from the connected camera(s) of the near-end video conference endpoint and performing detection methods on the output(s) for detecting the participants located at the near-end video conference endpoint.

The method 1500 further involves at 1504, detecting every participant in a collaboration space and detecting or identifying active speaker(s).

The method 1500 further involves at 1506, creating a speaker history based on the detected one or more active speakers. The speaker history is data about active participants at various points during the collaboration session. For example, the speaker history may be used to render current active speaker and two previous active speakers in a collaboration space in separate individual video frames.

The method 1500 further involves at 1508, calculating the video stream(s) from the camera(s) to include one or more participants. Specifically, at 1510, the output from the camera is cropped to include the views part of the initial/default framing(s) or at 1512, additional selected framing(s) are created and composed based on request by a receiver or the participant(s).

The method 1500 further involves at 1514, transmitting video streams from the near-end video conference endpoint to a collaboration server (such as the first collaboration server 110a) or further onto far-end video conference endpoint(s) and at 1516, transmitting metadata about alternative framing(s) to the collaboration server, and further onto far-end video conference endpoint(s).

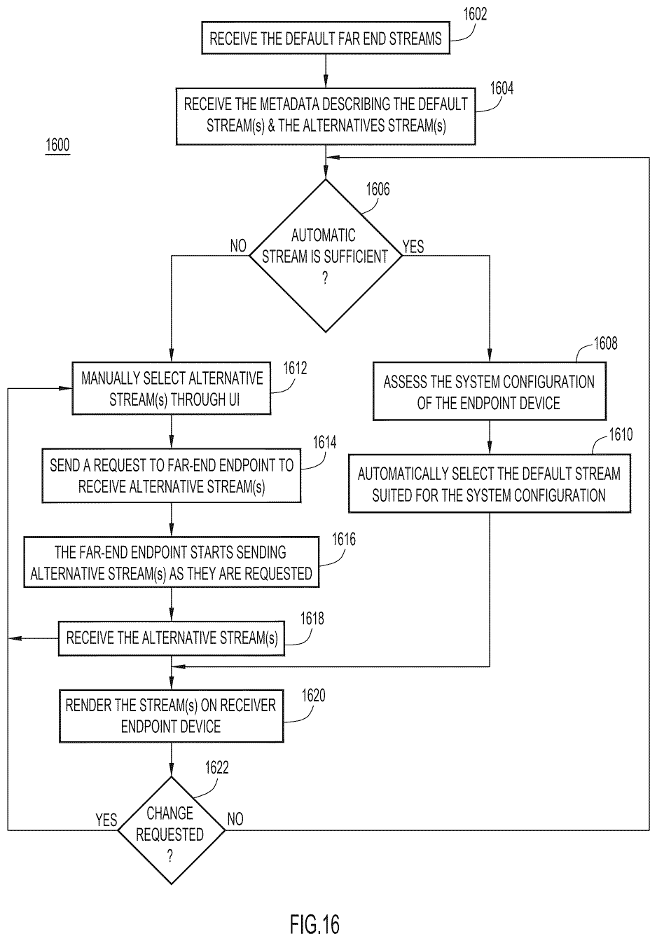

With continued reference to FIGS. 1-12, 13A, 13B, 14, and 15, FIG. 16 is a flowchart for a method 1600 of rendering a collaboration session on a receiving user device based on a generated layout, according to an example embodiment. The method 1600 is an example of processing for receiving user device(s). The method 1600 may be performed by a layout generator deployed on a collaboration server and/or a receiving user device such as the receiving user device 520 of FIG. 5. As such, in the method 1600, the receiving user device is a near-end endpoint device and the video endpoint device 108a of FIG. 1 or codec device 308 of FIG. 3 or 5 is a far-end endpoint device.

Specifically, the method 1600 involves at 1602, receiving the default far end video streams and at 1604, receiving the metadata describes the default stream(s) and the alternative stream(s). The default video streams obtained by the receiving user device may include a video stream for rendering an overview panel of a collaboration space and one or more video streams of selected participant(s) in the collaboration space e.g., current active speaker and previous active speaker to be rendered in separate individual video frames. These participant(s) in the collaboration space are selected based on a default selection criteria. The metadata may include information about other participant(s) in the collaboration space such as their names, their enterprises, detected location (x, y, z coordinates), etc.

The method 1600 further involves at 1606, determining whether the automatic stream is sufficient. Specifically, whether the user (a remote participant) is satisfied with the layout for rendering the collaboration session or whether changes are requested to the generated layout for rendering the collaboration session on the device of the user. If, it is determined that the automatic stream is sufficient (yes at 1606), a system configuration of the device is assessed, at 1608, and the default stream that is suitable for the system configuration is automatically selected, at 1610.

On the other hand, if it is determined that the automatic stream is not sufficient (no at 1606), at 1612, alternative video stream(s) are manually selected via the user interface, examples of which are in FIGS. 8-12, 13A, 13B, and 14. As such, at 1614, a request is transmitted to a far-end endpoint device to obtain or receive alternative video stream(s). Based on this request, at 1616, the far-end endpoint device starts transmitting alternative video stream(s) and at 1618, the alternative stream(s) are obtained or received by the near-end endpoint device.

At 1620, the streams are rendered on the receiver endpoint device according to the generated layout. Throughout the ongoing collaboration session, the receiver endpoint device monitors for any changes or modifications that may be requested. Specifically, at 1622, the receiver endpoint device determines if a change to the rendered collaboration session is requested. If no changes are requested, the method 1600 returns to the operation 1606. On the other hand, if a change is requested and new layout is to be generated, the method 1600 returns to operation 1612 in which a user specifies one or more changes to the rendered collaboration space (e.g., select meeting room participant(s), remove or change selected participant(s)).

The techniques presented herein revolutionize collaboration sessions by allowing remote participants to easily select and focus on specific individuals in a meeting room. By offering an effortlessly intuitive and customizable meeting experience, users can focus on enhancing their overall meeting engagement and reduce cognitive load. The techniques presented herein provide may further avoid crowded video layouts and/or system overload in transmitting high number of video streams. The techniques presented herein provide participants with flexibility of selecting whom to view in a collaboration space and how (proximity of the view). A layout generator generates layouts that have individual views panel adjustable on the fly, by a respective remote participant, during the collaboration session. Users select one or more participants from a meeting room to view in an individual frame in the individual views panel.

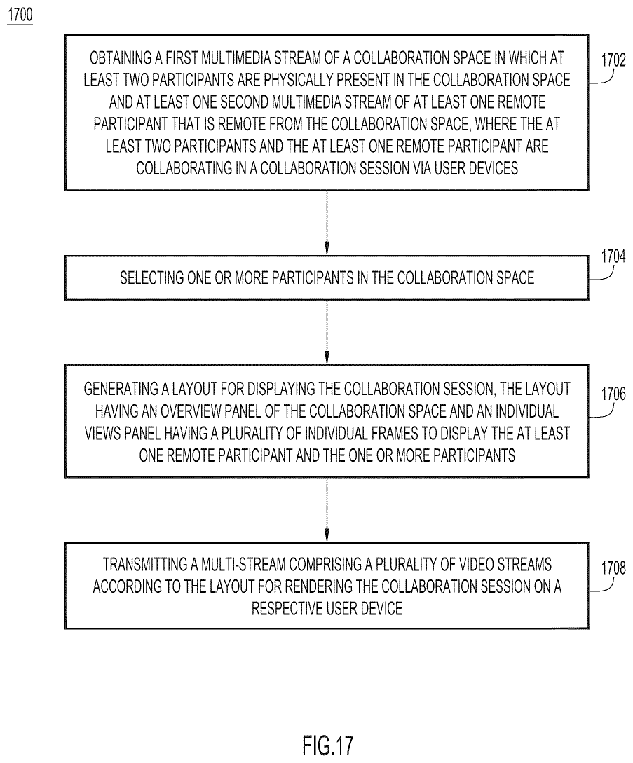

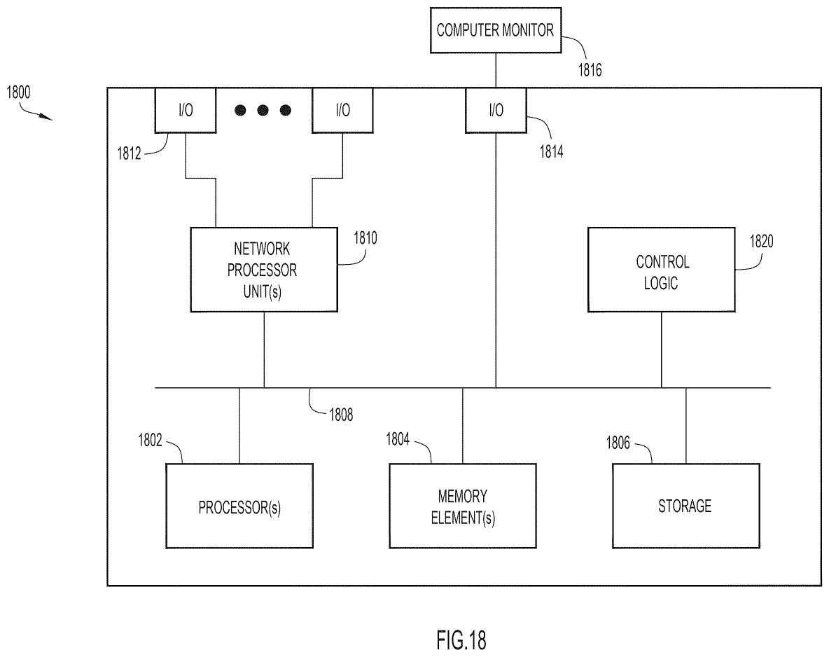

Turning now to FIG. 17, FIG. 17 is a flowchart depicting a method 1700 of transmitting a multi-stream that includes a plurality of video streams according to a generated layout, according to one or more example embodiments. The method 1700 may be performed by an apparatus or a computing device of FIG. 18 and/or one or more collaboration servers that implement the system described above, and/or in a cloud, or for example by the layout generator 112 of FIG. 1 or FIG. 5.

The method 1700 involves, at 1702, obtaining a first multimedia stream of a collaboration space in which at least two participants are physically present in the collaboration space and at least one second multimedia stream of at least one remote participant that is remote from the collaboration space. The at least two participants and the at least one remote participant are collaborating in a collaboration session via user devices.

The method 1700 further involves at 1704, selecting one or more participants in the collaboration space.

The method 1700 further involves at 1706, generating a layout for displaying the collaboration session. The layout has an overview panel of the collaboration space and an individual views panel having a plurality of individual frames to display the at least one remote participant and the one or more participants.

The method 1700 further involves at 1708, transmitting a multi-stream including a plurality of video streams according to the layout for rendering the collaboration session on a respective user device.

In one form, the operation 1704 of selecting the one or more participants in the collaboration space may involve obtaining a selection of the one or more participants in the collaboration space from the at least one remote participant.

In one instance, the individual views panel may include a dynamic panel to display the one or more participants. The method 1700 may further involve adjusting the dynamic panel based on an additional input from the at least one remote participant.

According to one or more example embodiments, the operation 1706 of generating the layout for displaying the collaboration session may involve generating the individual views panel by generating a remote views panel in which an individual frame is generated for each of the at least one remote participant and generating a dynamic panel in which the individual frame is generated for each selected participant of the one or more participants. The operation of generating the individual views panel may further involve integrating the remote views panel with the dynamic panel.

In another form, the method 1700 may further involve obtaining from the respective user device of the at least one remote participant, a selection of a specific frame from the plurality of individual frames in the dynamic panel and removing the specific frame from the layout based on the selection.

In one instance, the operation of 1706 of generating the layout for displaying the collaboration session may further involve obtaining a selection of a participant in the overview panel from the at least one remote participant and adding a new individual frame of the participant to the dynamic panel based on the selection.

According to one or more example embodiments, the operation 1706 of generating the layout for displaying the collaboration session may involve adding a first individual frame for a first selected participant of the one or more participants and adding a second individual frame for a second selected participant of the one or more participants. The operation 1706 of generating the layout for displaying the collaboration session may further involve positioning the first individual frame and the second individual frame in the individual views panel at locations that spatially correspond to a first location of the first selected participant and a second location of the second selected participant in the collaboration space.

In another instance, the operation 1706 of generating the layout for displaying the collaboration session may further involve selecting a view from a plurality of views of the first selected participant in the first individual frame. The plurality of views may be captured by a plurality of cameras in the collaboration space.

In yet another form, the method 1700 may further involve setting a selection criteria for selecting the one or more participants. The selection criteria may involve one or more of a participant type or participant actions.

FIG. 18 is a hardware block diagram of a computing device 1800 that may perform functions associated with any combination of operations in connection with the techniques depicted in FIGS. 1-12, 13A, 13B, 14-17, according to various example embodiments, including, but not limited to, operations of an apparatus such as an endpoint device of the user devices 102a-f, a video endpoint device 108a, a collaboration server of the collaboration servers 110a-g, the layout generator 112 of FIGS. 1 and 5, and/or the codec device 308 of FIGS. 3 and 5. It should be appreciated that FIG. 18 provides only an illustration of one example embodiment and does not imply any limitations with regard to the environments in which different embodiments may be implemented. Many modifications to the depicted environment may be made.

In at least one embodiment, computing device 1800 may include one or more processor(s) 1802, one or more memory element(s) 1804, storage 1806, a bus 1808, one or more network processor unit(s) 1810 interconnected with one or more network input/output (I/O) interface(s) 1812, one or more I/O interface(s) 1814, and control logic 1820. In various embodiments, instructions associated with logic for computing device 1800 can overlap in any manner and are not limited to the specific allocation of instructions and/or operations described herein.

In at least one embodiment, processor(s) 1802 is/are at least one hardware processor configured to execute various tasks, operations and/or functions for computing device 1800 as described herein according to software and/or instructions configured for computing device 1800. Processor(s) 1802 (e.g., a hardware processor) can execute any type of instructions associated with data to achieve the operations detailed herein. In one example, processor(s) 1802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1804 and/or storage 1806 is/are configured to store data, information, software, and/or instructions associated with computing device 1800, and/or logic configured for memory element(s) 1804 and/or storage 1806. For example, any logic described herein (e.g., control logic 1820) can, in various embodiments, be stored for computing device 1800 using any combination of memory element(s) 1804 and/or storage 1806. Note that in some embodiments, storage 1806 can be consolidated with one or more memory elements 1804 (or vice versa) or can overlap/exist in any other suitable manner.

In at least one embodiment, bus 1808 can be configured as an interface that enables one or more elements of computing device 1800 to communicate in order to exchange information and/or data. Bus 1808 can be implemented with any architecture designed for passing control, data and/or information between processors, memory elements/storage, peripheral devices, and/or any other hardware and/or software components that may be configured for computing device 1800. In at least one embodiment, bus 1808 may be implemented as a fast kernel-hosted interconnect, potentially using shared memory between processes (e.g., logic), which can enable efficient communication paths between the processes.

In various embodiments, network processor unit(s) 1810 may enable communication between computing device 1800 and other systems, entities, etc., via network I/O interface(s) 1812 to facilitate operations discussed for various embodiments described herein. In various embodiments, network processor unit(s) 1810 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1800 and other systems, entities, etc. to facilitate operations for various embodiments described herein. In various embodiments, network I/O interface(s) 1812 can be configured as one or more Ethernet port(s), Fibre Channel ports, and/or any other I/O port(s) now known or hereafter developed. Thus, the network processor unit(s) 1810 and/or network I/O interface(s) 1812 may include suitable interfaces for receiving, transmitting, and/or otherwise communicating data and/or information in a network environment.

I/O interface(s) 1814 allow for input and output of data and/or information with other entities that may be connected to computing device 1800. For example, I/O interface(s) 1814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1816, a display screen, or the like.

In various embodiments, control logic 1820 can include instructions that, when executed, cause processor(s) 1802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to communicate in a network, and a processor coupled to the network interface. The processor is configured to perform a method, which includes obtaining a first multimedia stream of a collaboration space in which at least two participants are physically present in the collaboration space and at least one second multimedia stream of at least one remote participant that is remote from the collaboration space. The at least two participants and the at least one remote participant are collaborating in a collaboration session via user devices. The method may further involve selecting one or more participants in the collaboration space and generating a layout for displaying the collaboration session. The layout has an overview panel of the collaboration space and an individual views panel having a plurality of individual frames to display the at least one remote participant and the one or more participants. The method may further involve transmitting a multi-stream including a plurality of video streams according to the layout for rendering the collaboration session on a respective user device.

In yet another example embodiment, one or more non-transitory computer readable storage media encoded with instructions are provided. When the media is executed by a processor, the instructions cause the processor to execute a method, which includes obtaining a first multimedia stream of a collaboration space in which at least two participants are physically present in the collaboration space and at least one second multimedia stream of at least one remote participant that is remote from the collaboration space. The at least two participants and the at least one remote participant are collaborating in a collaboration session via user devices. The method may further involve selecting one or more participants in the collaboration space and generating a layout for displaying the collaboration session. The layout has an overview panel of the collaboration space and an individual views panel having a plurality of individual frames to display the at least one remote participant and the one or more participants. The method may further involve transmitting a multi-stream comprising a plurality of video streams according to the layout for rendering the collaboration session on a respective user device.

In yet another example embodiment, a system is provided that includes the devices and operations explained above with reference to FIGS. 1-12, 13A, 13B, and 14-18.

The programs described herein (e.g., control logic 1820) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1806 and/or memory elements(s) 1804 can store data, software, code, instructions (e.g., processor instructions), logic, parameters, combinations thereof, and/or the like used for operations described herein. This includes the storage 1806 and/or memory elements(s) 1804 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a first multimedia stream of a collaboration space in which at least two participants are physically present in the collaboration space and at least one second multimedia stream of at least one remote participant that is remote from the collaboration space, wherein the at least two participants and the at least one remote participant are collaborating in a collaboration session via user devices;
selecting one or more participants in the collaboration space;
generating a layout for displaying the collaboration session, the layout having an overview panel of the collaboration space and an individual views panel having a plurality of individual frames to display the at least one remote participant and the one or more participants; and
transmitting a multi-stream comprising a plurality of video streams according to the layout for rendering the collaboration session on a respective user device.

2. The method of claim 1, wherein selecting the one or more participants in the collaboration space includes:
obtaining a selection of the one or more participants in the collaboration space from the at least one remote participant.

3. The method of claim 2, wherein the individual views panel includes a dynamic panel to display the one or more participants, and the method further comprising:
adjusting the dynamic panel based on an additional input from the at least one remote participant.

4. The method of claim 1, wherein generating the layout for displaying the collaboration session includes:
generating a custom layout specific to each remote participant based on one or more selections by a respective remote participant.

5. The method of claim 1, wherein generating the layout for displaying the collaboration session includes generating the individual views panel by:
generating a remote views panel in which an individual frame is generated for each of the at least one remote participant;
generating a dynamic panel in which the individual frame is generated for each selected participant of the one or more participants; and
integrating the remote views panel with the dynamic panel.

6. The method of claim 5, further comprising:
obtaining, from the respective user device of the at least one remote participant, a selection of a specific frame from the plurality of individual frames in the dynamic panel; and
removing the specific frame from the layout based on the selection.

7. The method of claim 5, wherein generating the layout for displaying the collaboration session further includes:
obtaining a selection of a participant in the overview panel from the at least one remote participant; and
adding a new individual frame of the participant to the dynamic panel based on the selection.

8. The method of claim 1, wherein generating the layout for displaying the collaboration session includes:
adding a first individual frame for a first selected participant of the one or more participants;
adding a second individual frame for a second selected participant of the one or more participants; and
positioning the first individual frame and the second individual frame in the individual views panel at locations that spatially correspond to a first location of the first selected participant and a second location of the second selected participant in the collaboration space.

9. The method of claim 8, wherein generating the layout for displaying the collaboration session further includes:
selecting a view from a plurality of views of the first selected participant in the first individual frame, wherein the plurality of views are captured by a plurality of cameras in the collaboration space.

10. The method of claim 1, further comprising:
setting a selection criteria for selecting the one or more participants, wherein the selection criteria includes one or more of a participant type or participant actions.

11. An apparatus comprising:
a memory;
a network interface configured to enable network communications; and
a processor, wherein the processor is configured to perform a method comprising:
obtaining a first multimedia stream of a collaboration space in which at least two participants are physically present in the collaboration space and at least one second multimedia stream of at least one remote participant that is remote from the collaboration space, wherein the at least two participants and the at least one remote participant are collaborating in a collaboration session via user devices;
selecting one or more participants in the collaboration space;
generating a layout for displaying the collaboration session, the layout having an overview panel of the collaboration space and an individual views panel having a plurality of individual frames to display the at least one remote participant and the one or more participants; and
transmitting a multi-stream comprising a plurality of video streams according to the layout for rendering the collaboration session on a respective user device.

12. The apparatus of claim 11, wherein the processor is configured to select the one or more participants in the collaboration space by:
obtaining a selection of the one or more participants in the collaboration space from the at least one remote participant.

13. The apparatus of claim 12, wherein the individual views panel includes a dynamic panel to display the one or more participants, and the processor is further configured to perform:
adjusting the dynamic panel based on an additional input from the at least one remote participant.

14. The apparatus of claim 11, wherein the processor is configured to generate the layout for displaying the collaboration session by:
generating a custom layout specific to each remote participant based on one or more selections by a respective remote participant.

15. The apparatus of claim 11, wherein the processor is configured to generate the layout for displaying the collaboration session includes generating the individual views panel by:
generating a remote views panel in which an individual frame is generated for each of the at least one remote participant;
generating a dynamic panel in which the individual frame is generated for each selected participant of the one or more participants; and
integrating the remote views panel with the dynamic panel.

16. The apparatus of claim 15, wherein the processor is configured to perform:
obtaining, from the respective user device of the at least one remote participant, a selection of a specific frame from the plurality of individual frames in the dynamic panel; and
removing the specific frame from the layout based on the selection.

17. One or more non-transitory computer readable storage media encoded with software comprising computer executable instructions that, when executed by a processor, cause the processor to perform a method including:
obtaining a first multimedia stream of a collaboration space in which at least two participants are physically present in the collaboration space and at least one second multimedia stream of at least one remote participant that is remote from the collaboration space, wherein the at least two participants and the at least one remote participant are collaborating in a collaboration session via user devices;
selecting one or more participants in the collaboration space;
generating a layout for displaying the collaboration session, the layout having an overview panel of the collaboration space and an individual views panel having a plurality of individual frames to display the at least one remote participant and the one or more participants; and
transmitting a multi-stream comprising a plurality of video streams according to the layout for rendering the collaboration session on a respective user device.

18. The one or more non-transitory computer readable storage media according to claim 17, wherein the computer executable instructions cause the processor to select the one or more participants in the collaboration space by:
obtaining a selection of the one or more participants in the collaboration space from the at least one remote participant.

19. The one or more non-transitory computer readable storage media according to claim 18, wherein the individual views panel includes a dynamic panel to display the one or more participants and wherein the computer executable instructions cause the processor to perform:
adjusting the dynamic panel based on an additional input from the at least one remote participant.

20. The one or more non-transitory computer readable storage media according to claim 17, wherein the computer executable instructions cause the processor to generate the layout for displaying the collaboration session by:
generating a custom layout specific to each remote participant based on one or more selections by a respective remote participant.
